(19) United States
(12) Patent Application Publication
(10) Pub. No.: US 2026/0257380 A1
(43) Pub. Date: Sep. 3, 2026

(54) ARTICLE HOLDING DEVICE

(71) Applicant: DAIFUKU CO., LTD., Osaka (JP)

(72) Inventors: Shuzo NISHINO, Osaka (JP); Hideaki YAMANARI, Shiga (JP)

(73) Assignee: DAIFUKU CO., LTD., Osaka (JP)

(21) Appl. No.: 19/531,834

(22) Filed: Feb. 6, 2026

(30) Foreign Application Priority Data
Feb. 28, 2025 (JP) 2025-031900

(51) Int. Cl. B25J 15/06

(52) U.S. Cl. CPC B25J 15/0683

(57) ABSTRACT

This disclosure improves adsorption performance of an adsorption pad with respect to an article. An article holding device includes: a pad attachment part provided with a suction port; an adsorption pad that is attached to the pad attachment part and that is configured to adsorb the article; and a pressing part that is movable relative to the pad attachment part and that is configured to press the adsorption pad toward the article in an adsorbing state of the article.

This Nonprovisional application claims priority under 35 U.S.C. § 119 on Patent Application No. 2025-031900 filed in Japan on Feb. 28, 2025, the entire contents of which are hereby incorporated by reference.

### TECHNICAL FIELD

The present disclosure relates to an article holding device that holds an article by an adsorption pad.

### BACKGROUND ART

In recent years, a picking device (transfer device) is used in factories, warehouses, etc., in order to efficiently sort various kinds of many articles according to shipment destinations. Such a picking device includes an adsorption pad that adsorbs an article, and is configured to transfer the article to a desired position while adsorbing the article by the adsorption pad.

Patent Literature 1 discloses an adsorption pad including a contact part that is configured to come into contact with an article and that is provided with an elastic petal-shaped part having portions separated by a plurality of recesses. This type of adsorption pad is used in a state in which the adsorption pad is attached to a tip end of a picking device having a suction port, for example.

### CITATION LIST

### Patent Literatures

### Patent Literature 1

Japanese Patent Application Publication, Tokukai, No. 2020-89936

### SUMMARY OF INVENTION

### Technical Problem

However, in the above-described conventional technique, there is room for improvement in adsorption performance. Specifically, the above-described conventional technique causes suction to elastically deform the adsorption pad, thereby allowing the adsorption pad to come into close contact with an article. Thus, depending on the shape of the article, the adsorption pad may not come into close contact with the article.

An aspect of the present disclosure was made in light of the above-explained conventional problem, and has an objective to improve adsorption performance of an adsorption pad with respect to an article.

### Solution to Problem

In order to attain the above objective, an article holding device in accordance with an aspect of the present disclosure includes: a pad attachment part that is provided with a suction port; an adsorption pad that is attached to the pad attachment part and that is configured to adsorb an article; and a pressing part that is movable relative to the pad attachment part along a direction of a center axis of the suction port and that is configured to press the adsorption pad toward the article in an adsorbing state of the article.

### Advantageous Effects of Invention

In accordance with an aspect of the present disclosure, it is possible to provide an article holding device capable of improving adsorption performance of an adsorption pad with respect to an article.

### BRIEF DESCRIPTION OF DRAWINGS

FIG. 1 is a view schematically illustrating an example of a configuration of a main part of an article holding device in accordance with a first embodiment of the present disclosure.

FIG. 2 is a view schematically illustrating an example of operation of the article holding device shown in FIG. 1.

FIG. 3 is a view illustrating an end surface of a variation of the adsorption pad shown in FIG. 1.

FIG. 4 is a view schematically illustrating an example of operation of an article holding device including the adsorption pad shown in FIG. 3.

FIG. 5 is a view illustrating an end surface of another variation of the adsorption pad shown in FIG. 1.

FIG. 6 is a view schematically illustrating an example of operation of an article holding device including the adsorption pad shown in FIG. 5.

FIG. 7 is a view schematically illustrating an example of operation of an article holding device including the adsorption pad that is shown in FIG. 6 and that additionally includes an extended part.

FIG. 8 is a view schematically illustrating an example of a configuration of a main part of an article holding device in accordance with a second embodiment of the present disclosure.

FIG. 9 is a view schematically illustrating an example of operation of the article holding device shown in FIG. 8.

### DESCRIPTION OF EMBODIMENTS

### First Embodiment

The following description will discuss an embodiment of the present disclosure. The following explanation will deal with a case where an article holding device in accordance with the present disclosure employs a picking device (transfer device) that is configured to transfer an article while adsorbing the article. Note that the following explanation deals with one example of the article holding device in accordance with the present disclosure, and the technical scope of the present disclosure is not limited to the example shown in the drawings.

### Outline of Article Holding Device

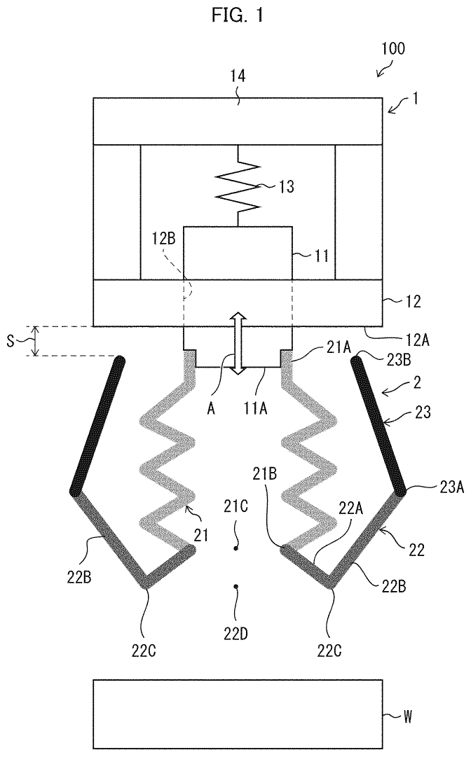

First, the following will describe an overview of an article holding device 100 in accordance with the present embodiment with reference to FIG. 1. FIG. 1 is a view schematically illustrating an example of a configuration of a main part of the article holding device 100 in accordance with the present embodiment. The article holding device 100 is provided at, e.g., a tip end of a robot arm constituting a picking device, and is used to adsorb an article W.

As shown in FIG. 1, the article holding device 100 includes: a pad attachment part 11 that is provided with a suction port 11A; an adsorption pad 2 that is attached to the pad attachment part 11; and a pressing part 12 that is movable relative to the pad attachment part 11 along a direction of a center axis A and that is configured to press the adsorption pad 2 toward an article W in an adsorbing state of the article W.

The article holding device 100 is configured such that the pad attachment part 11 and the pressing part 12 are relatively movable so that the pressing part 12 presses the adsorption pad 2 toward the article W in an adsorbing state of the article W. This makes it easier to bring the adsorption pad 2 into close contact with the article W, thereby improving adsorption performance of the adsorption pad 2 with respect to the article W.

### Configuration of Article Holding Device

Next, the following description will discuss an example of a configuration of the article holding device 100 with reference to FIG. 1. As shown in FIG. 1, the article holding device 100 includes a head part 1 and the adsorption pad 2 attached to the head part 1.

For convenience of explanation, the drawings of the present disclosure merely illustrate an end surface of the adsorption pad 2, taken by cutting the adsorption pad 2 along a plane that passes through the center axis A of the suction port (suction hole) 11A.

In the following description of the present disclosure, a direction along the center axis A of the suction port 11A may be referred to as an “up-down direction”, whereas a direction orthogonal to the up-down direction may be referred to as a “transverse direction”. Further, along the up-down direction, a side on which the head part 1 is located may be referred to as an “upward” side, whereas a side on which the adsorption pad 2 is located may be referred to as a “downward” side.

### Head Part

The head part 1 can be rotatably attached to the tip end of the robot arm, for example. The head part 1 includes the pad attachment part 11, the pressing part 12, and a spring (elastic member) 13.

The pad attachment part 11 is a tubular member to which the adsorption pad 2 is attached. The pad attachment part 11 has, at its lower end, the suction port 11A for sucking air. The suction port 11A is connected with a vacuum pump (not illustrated), and is configured to suck air therethrough.

The article holding device 100 is configured such that the adsorption pad 2 is brought into contact with the article W and vacuum drawing is carried out through the suction port 11A, whereby the adsorption pad 2 is elastically deformed to adsorb and hold the article W.

In an example configuration shown in the present embodiment, a single adsorption pad 2 is provided to the head part 1. Alternatively, the head part 1 may be provided with a plurality of (three) pad attachment parts 11 and each of the plurality of pad attachment parts 11 may have a single adsorption pad 2 attached thereto.

The pressing part 12 is a plate-shaped member disposed at a lower part of the head part 1. The pressing part 12 may constitute a part (bottom) of a housing 14 of the head part 1. The pressing part 12 is disposed so as to be orthogonal to a direction of the center axis A of the suction port 11A. The pressing part 12 has an opposing surface (lower surface) which faces the adsorption pad 2 and which serves as a pressing surface 12A. In an adsorbing state of the article W, the pressing surface 12A is configured to come into contact with the adsorption pad 2 and press the adsorption pad 2 toward the article W.

The pressing surface 12A may be constituted by a flat surface. Due to the configuration in which the pressing surface 12A is flat, the pressing surface 12A is hardly caught by the adsorption pad 2, which allows the adsorption pad 2 to easily move (tilt) according to the shape of the article W.

Note, however, that the pressing surface 12A is not limited to the flat shape. The pressing surface 12A may have a shape including a protruded part that protrudes toward the adsorption pad 2. Consequently, the protruded part effectively presses the adsorption pad 2 toward the article W, whereby the adsorption pad 2 is likely to be brought into close contact with the article W.

Further, the pressing part 12 has an insertion hole 12B penetrating through the pressing part 12 in a thickness direction (i.e., the direction of the center axis A) of the pressing part 12. The insertion hole 12B is provided in a center of the pressing part 12 in a plan view. Through the insertion hole 12B, the pad attachment part 11 is inserted.

The pad attachment part 11 in the head part 1 is attached to the housing 14 of the head part 1 via the spring 13 made of, e.g., a coil spring. This allows the pad attachment part 11 to move along the insertion hole 12B. Thus, in the present embodiment, the pad attachment part 11 is configured to be movable relative to the pressing part 12 along the direction of the center axis A of the suction port 11A.

Note that the pad attachment part 11 and the spring 13 may be made of, e.g., a spring plunger. In this case, the spring plunger may be fixed to the pressing part 12 such that a tip end (suction port 11A) of the spring plunger protrudes toward the adsorption pad 2 through the insertion hole 12B of the pressing part 12.

### Adsorption Pad

The adsorption pad 2 is a vacuum adsorption pad that is elastically deformed by vacuum pressure so as to adsorb the article W. The entire adsorption pad 2 has a substantially tubular shape. The adsorption pad 2 includes a suction part 21, an adsorption part 22, and a shape maintaining part 23.

The adsorption pad 2 is attached to the pad attachment part 11 such that the shape maintaining part 23 does not come into contact with the pressing part 12 in a non-adsorbing state of the article W, i.e., while the article W is not being adsorbed, that is to say, while the adsorption pad 2 is not subjected to external force and is not substantially deformed. Consequently, the article holding device 100 has a space S between the shape maintaining part 23 and the pressing part 12. That is, the adsorption pad 2 is a floating pad that is configured to prevent the shape maintaining part 23 from coming into contact with the head part 1 in a non-adsorbing state of the article W. Thanks to the configuration in which the adsorption pad 2 is in a floating state, the adsorption pad 2 is likely to be tilted along with tilting of the article W, for example. This improves the adsorption performance of the adsorption pad 2 with respect to the article W.

The suction part 21 is made of, for example, a resin material that is elastically deformable, such as a silicon resin. The suction part 21 is in the shape of a bellows tube, for example. The suction part 21 has a first end 21A that is an end closer to the pad attachment part 11 and that has a ring shape. The first end 21A is connected with the pad attachment part 11. By connecting the first end 21A of the suction part 21 with the pad attachment part 11, the adsorption pad 2 is attached to the pad attachment part 11.

Further, the suction part 21 has a second end 21B that is an end opposite to the pad attachment part 11 and that has a ring shape. The second end 21B has a circular opening 21C in a plan view.

The adsorption part 22 is made of, for example, a resin material that is elastically deformable, such as a silicon resin. The adsorption part 22 is connected with the second end 21B of the suction part 21. Specifically, the adsorption part 22 has a first adsorption part 22A and a second adsorption part 22B. The first adsorption part 22A is connected with the second end 21B of the suction part 21 and has a diameter which increases with increasing distance from the suction part 21. The second adsorption part 22B is bent relative to the first adsorption part 22A toward the pad attachment part 11 and has a diameter which increases with increasing distance from the first adsorption part 22A.

In other words, the adsorption part 22 is constituted by the first adsorption part 22A and the second adsorption part 22B, and includes a bent part 22C bent at a lower end of the adsorption pad 2 so as to extend toward the pad attachment part 11, for example.

In the adsorption part 22, the first adsorption part 22A and the second adsorption part 22B are both made of a material that is elastically deformable. The bent part 22C has a ring shape in a non-adsorbing state of the article W. Meanwhile, in an adsorbing state of the article W, the bent part 22C can be deformed from the ring shape as appropriate in accordance with elastic deformation of at least one of the first adsorption part 22A and the second adsorption part 22B.

In the adsorption part 22, an opening 22D is provided on an inner side of the bent part 22C that has a ring shape. The opening 22D is sequentially communicated with the opening 21C of the suction part 21 and the suction port 11A of the pad attachment part 11. This allows the article W to be sucked in an adsorbing state of the article W.

The shape maintaining part 23 is formed of, for example, the same material as that of the adsorption part 22. The shape maintaining part 23 is disposed around the suction part 21, and is configured to maintain the shape of the second adsorption part 22B not during adsorption of the article W. In other words, the shape maintaining part 23 has a function of restoring the shape of the second adsorption part 22B, which has been elastically deformed in an adsorbing state of the article W, to its original shape before the elastic deformation. The shape maintaining part 23 may be configured to have higher rigidity than the adsorption part 22.

For example, the shape maintaining part 23 is formed of an elastically deformable resin material such as a silicon resin, which is the same as that of the adsorption part 22, and is integrated with the adsorption part 22. Further, the shape maintaining part 23, which has a ring shape, has a first end 23A connected with the second adsorption part 22B of the adsorption part 22, and is formed to have a diameter that decreases with increasing distance from the second adsorption part 22B. The shape maintaining part 23 has a second end 23B formed in a ring shape having a predetermined thickness in order to provide the shape maintaining part 23 with higher rigidity than the adsorption part 22.

Further, as described above, the shape maintaining part 23 is configured such that the second end 23B, which is a tip end of the shape maintaining part 23, is separated from the pressing surface 12A of the pressing part 12 in a non-adsorbing state of the article W. Thus, in a non-adsorbing state of the article W, the shape maintaining part 23 is in a floating state, rather than being in contact with the pressing surface 12A. This makes it easier for the adsorption pad 2 to move in accordance with the shape of the article W in an adsorbing state of the article W.

Note that there is no particular limitation on the material of the shape maintaining part 23, provided that it allows the second adsorption part 22B to maintain its shape in a non-adsorbing state of the article W. The shape maintaining part 23 may be formed of a material different from that of the adsorption part 22. For example, the shape maintaining part 23 may be formed of a member such as a metal material.

In order to appropriately maintain the shape of the adsorption part 22 by the shape maintaining part 23 in a non-adsorbing state of the article W, it is preferable that the shape maintaining part 23 have higher rigidity than the adsorption part 22. With the configuration that the shape maintaining part 23 has higher rigidity than the adsorption part 22, the shape of the second adsorption part 22B of the adsorption part 22, having been elastically deformed in an adsorbing state of the article W, can easily be restored to its original shape before the adsorption.

### Operation of Article Holding Device

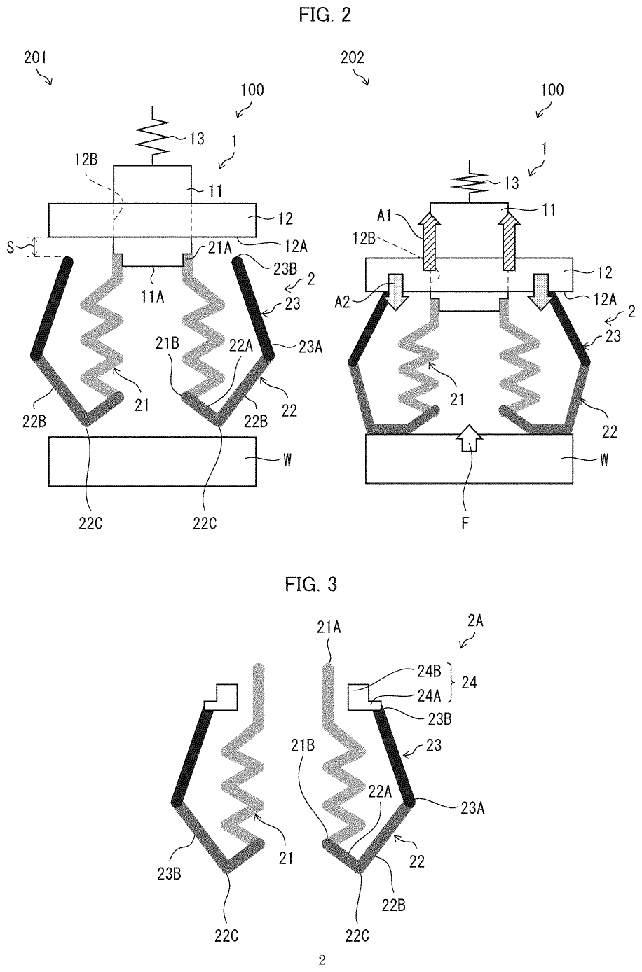

Next, the following description will discuss an example of operation of the article holding device 100 with reference to FIG. 2. FIG. 2 is a view schematically illustrating an example of operation of the article holding device 100. The reference sign “201” in FIG. 2 illustrates a state in which adsorption of the article W is not carried out, whereas the reference sign “202” in FIG. 2 illustrates a state in which adsorption of the article W is carried out.

When the article holding device 100 is lowered toward the article W from the state in which adsorption is not carried out (indicated by the reference sign “201” in FIG. 2), the bent part 22C of the adsorption pad 2 first comes into contact with the article W. Subsequently, the adsorption pad 2 is pressed against the article W, so that the adsorption pad 2 is elastically deformed in accordance with the shape of the article W. Consequently, as indicated by the reference sign “202” in FIG. 2, the first adsorption part 22A and the second adsorption part 22B of the adsorption part 22 come into close contact with an adsorbed surface of the article W.

During this, as the article holding device 100 is lowered, the pressing part 12 moves downward. Meanwhile, since the adsorption pad 2 comes into contact with the article W, downward movement of the pad attachment part 11, which is connected with the adsorption pad 2, is restricted. Consequently, as indicated by the reference sign “202” in FIG. 2, as the pressing part 12 moves downward, the pad attachment part 11 is pressed into the insertion hole 12B, so that the spring 13 is contracted (compressed). As a result, as indicated by the arrows A1 in the view with the reference sign “202”, the pad attachment part 11 moves upward relative to the pressing part 12.

In this manner, the pad attachment part 11, together with the adsorption pad 2, moves upward relative to the pressing part 12. Consequently, as indicated by the arrows A2 in the view with the reference sign “202” in FIG. 2, the pressing part 12 presses the shape maintaining part 23 toward the article W. This makes it much easier to bring the adsorption pad 2 into close contact with the article W, thereby improving the adsorption performance of the adsorption pad 2 with respect to the article W. As a result, vacuum drawing is carried out through the suction port 11A. Consequently, as indicated by the arrow F in the view with the reference sign “202” in FIG. 2, the adsorption pad 2 adsorbs the article W so as to hold the article W in a stable manner.

After the article holding device 100 transfers the article W held thereby to a desired position, the spring 13 extends so as to cause the pad attachment part 11 to move downward relative to the pressing part 12. Consequently, the article holding device 100 returns to the state in which adsorption of the article W is not carried out (indicated by the reference numeral “201” in FIG. 2). In other words, the article holding device 100 is configured such that the pressing part 12 carries out reciprocation movement in an up-down direction relative to the pad attachment part 11.

A stroke length of the relative reciprocation movement of the pressing part 12 relative to the pad attachment part 11 may be not less than a length of the space S in the up-down direction and not more than a sum of the length of the space S and a maximum deformation amount of the adsorption pad 2 in the up-down direction. In the present disclosure, the “maximum deformation amount of the adsorption pad 2 in the up-down direction” refers to a maximum compression amount (i.e., a maximum deformable amount) observed when the adsorption pad 2 is compressed in the up-down direction, and is defined as a deformation amount of the adsorption pad 2 in the up-down direction observed at a timing when the adsorption pad 2 loses its flexibility and rapidly increases its rigidity.

In this case, when the article holding device 100 is lowered toward the article W, during a first period from a time point that the adsorption part 22 of the adsorption pad 2 comes into contact with the article W to a time point that the shape maintaining part 23 of the adsorption pad 2 comes into contact with the pressing part 12, the adsorption pad 2 is pressed against the article W only by a biasing force of the spring 13, i.e., with a quite weak force (approximately 0 to 70 g). Thus, during the first period, the adsorption pad 2 is hardly elastically deformed.

Subsequently, during a second period from a time point that the pressing part 12 comes into contact with the shape maintaining part 23 of the adsorption pad 2 to a time point that the pressing part 12 reaches the stroke end at which the spring 13 is most contracted, the pressing force exerted by the pressing part 12 is partially absorbed by contraction of the spring 13. Consequently, the adsorption pad 2 is pressed against the article W with a weak force (up to approximately 250 g). During the second period, the adsorption pad 2 starts elastic deformation (initial deformation).

Subsequently, during a third period after the pressing part 12 has reached the stroke end at which the spring 13 is most contracted, the adsorption pad 2 is elastically deformed (later deformation) nearly up to the maximum deformation amount as the article holding device 100 is lowered. Thus, the adsorption pad 2 is pressed against the article W with a strong force (up to approximately 500 g) by the elastic force of the adsorption pad 2.

In this manner, by adjusting the stroke length of the relative reciprocation movement of the pressing part 12 relative to the pad attachment part 11 so as to fall within the above-described range, for example, the adsorption part 22 of the adsorption pad 2 can be brought into close contact with the article W with a relatively weak force during the first period and the second period. Thus, it is possible to suitably adsorb the article W which is easily deformed (e.g., a stand pouch).

### Effects of Article Holding Device

As described above, the article holding device 100 in accordance with the present embodiment includes: the pad attachment part 11 that is provided with the suction port 11A; the adsorption pad 2 that is attached to the pad attachment part 11 and that is configured to adsorb the article W; and the pressing part 12 that is movable relative to the pad attachment part 11 along the direction of the center axis A of the suction port 11A and that is configured to press the adsorption pad 2 toward the article W in an adsorbing state of the article W.

The article holding device 100 is configured such that the pad attachment part 11 and the pressing part 12 are relatively movable so that the pressing part 12 presses the adsorption pad 2 toward the article W in an adsorbing state of the article W. Thus, the present embodiment makes it easier to bring the adsorption pad 2 into close contact with the article W, thereby improving the adsorption performance of the adsorption pad 2 with respect to the article W.

### Variations

### Variation 1

FIG. 3 is a view illustrating an end surface of an adsorption pad 2A, which is a variation of the adsorption pad 2. As shown in FIG. 3, the adsorption pad 2A includes an annular member 24 that is fixed to a second end 23B of a shape maintaining part 23 which second end 23B faces a pressing part 12 and that is located around a suction part 21. The annular member 24 is formed in a ring shape and is configured to have higher rigidity than the shape maintaining part 23. The annular member 24 may be formed of a material which is hardly elastically deformed, such as a synthetic resin (e.g., a plastic) or a metal material.

Note that the shape of the annular member 24 is not limited to a ring shape (circular shape). The annular member 24 can be modified as appropriate in accordance with, e.g., the shape of the pressing part 12 or the shape of the second end 23B of the shape maintaining part 23. The annular member 24 may have, for example, an elliptical shape or a polygonal shape (e.g., a star shape).

The annular member 24 may include a large-diameter part 24A fixed to the second end 23B of the shape maintaining part 23 and a small-diameter part 24B that is located closer to the pressing part 12 than the large-diameter part 24A and that is configured to be pressed by the pressing part 12 in an adsorbing state of the article W.

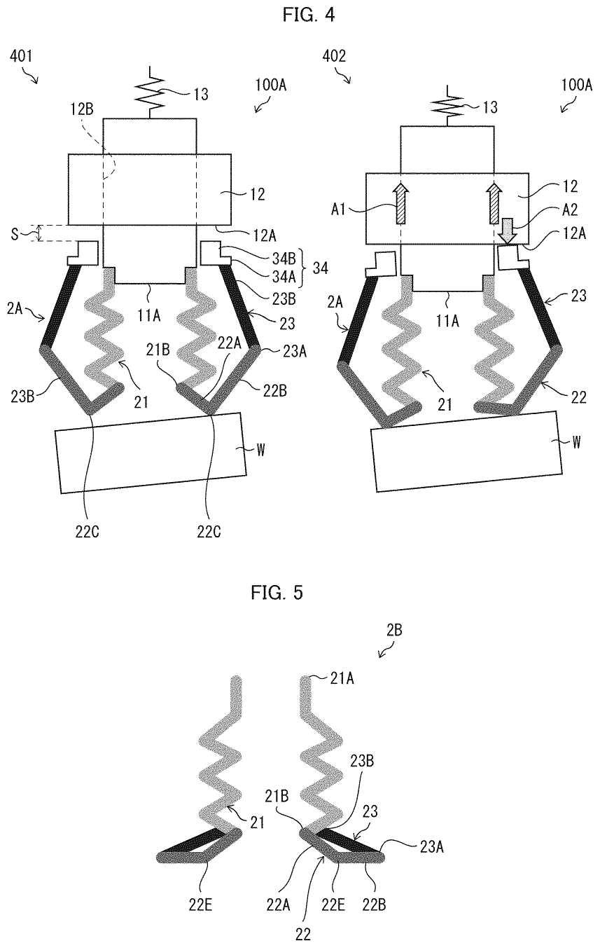

FIG. 4 is a view schematically illustrating an example of operation of an article holding device 100A including the adsorption pad 2A shown in FIG. 3. The reference sign “401” in FIG. 4 illustrates a state in which the adsorption pad 2A is in contact with the article W disposed in a tilted manner, whereas the reference sign “402” in FIG. 4 illustrates a state in which the adsorption pad 2A is tilted in accordance with tilting of the article W.

As shown in the view with the reference sign “401” in FIG. 4, when the article holding device 100 is lowered toward the article W disposed in a tilted manner, a part (a right-side part of the bent part 22C in the view with the reference sign “401” in FIG. 4) of the bent part 22C of the adsorption pad 2 first comes into contact with the article W. Subsequently, when the article holding device 100 is further lowered, the adsorption pad 2A is tilted in accordance with tilting of an adsorbed surface of the article W, and the small-diameter part 24B of the annular member 24, which is fixed to the second end 23B of the shape maintaining part 23, comes into contact with the pressing part 12. During this, the annular member 24 has such rigidity that the annular member 24 hardly undergoes elastic deformation, thereby suppressing elastic deformation of the shape maintaining part 23. This makes it easier to maintain the state in which the adsorption pad 2A is tilted along the adsorbed surface of the article W. This improves the adsorption performance of the adsorption pad 2A with respect to the inclined article W.

Further, thanks to the configuration in which the annular member 24 includes the large-diameter part 24A and the small-diameter part 24B, the pressing part 12 only needs to have a dimension that allows the pressing part 12 to press the small-diameter part 24B. This makes it possible to reduce an outer diameter dimension of the pressing part 12 in a transverse direction, which makes it possible to reduce the size of the pressing part 12.

### Variation 2

FIG. 5 is a view illustrating an end surface of an adsorption pad 2B, which is another variation of the adsorption pad 2. As shown in FIG. 5, the adsorption pad 2B includes an adsorption part 22 that includes a first adsorption part 22A and a second adsorption part 22B. The first adsorption part 22A is connected with a second end 21B of a suction part 21, and has a diameter which increases with increasing distance from the suction part 21. The second adsorption part 22B is bent relative to the first adsorption part 22A so as to extend toward a radially outer side of the adsorption pad 2B.

In other words, the adsorption part 22 of the adsorption pad 2B is constituted by the first adsorption part 22A and the second adsorption part 22B, and includes a bent part 22E that is bent at a lower end of the adsorption pad 2B so as to extend radially outward. Note that the adsorption part 22 may be formed in a radial (multi-petal) shape in a plan view.

Further, a shape maintaining part 23 of the adsorption pad 2B is disposed around the first adsorption part 22A, and is configured to maintain the shape of the second adsorption part 22B in a non-adsorbing state of an article W.

For example, the shape maintaining part 23, which has a ring shape, has a first end 23A connected with the second adsorption part 22B of the adsorption part 22 and is formed to have a diameter that decreases with increasing distance from the second adsorption part 22B. Furthermore, the shape maintaining part 23, which has a ring shape, has a second end 23B connected with a second end 21B of the suction part 21.

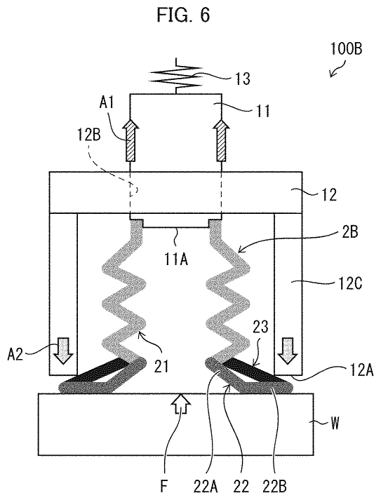

FIG. 6 is a view schematically illustrating an example of operation of an article holding device 100B including the adsorption pad 2B shown in FIG. 5. FIG. 6 shows a state in which adsorption of the article W is carried out.

As shown in FIG. 6, a pressing part 12 of the article holding device 100B includes an annular protruded part 12C, which is a part of a pressing surface 12A protruding toward the adsorption pad 2B. In the article holding device 100B, the pressing surface 12A, which is at a tip end of the protruded part 12C, presses the shape maintaining part 23 of the adsorption pad 2B toward the article W in an adsorbing state of the article W. This makes it much easier to bring the adsorption pad 2B into close contact with the article W, thereby improving the adsorption performance of the adsorption pad 2B with respect to the article W.

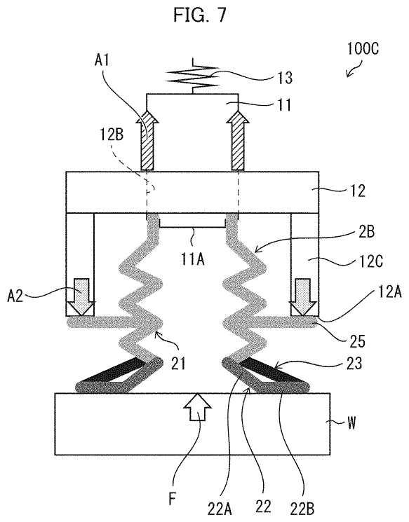

FIG. 7 is a view schematically illustrating an example of operation of an article holding device 100C including the adsorption pad 2B that is shown in FIG. 6 and that additionally includes an extended part 25. FIG. 7 shows a state in which adsorption of an article W is carried out.

As shown in FIG. 7, the adsorption pad 2B may include the extended part 25 which is extended radially outward from an outer peripheral part of the suction part 21. The extended part 25 may be integrated with the adsorption pad 2B, or may be provided as a member separated from the adsorption pad 2B. In a case where the extended part 25 is integrated with the adsorption pad 2B, the extended part 25 may have higher rigidity than the shape maintaining part 23. Meanwhile, in a case where the extended part 25 is provided as a member separated from the adsorption pad 2B, the extended part 25 may be formed of a material which is hardly elastically deformed, such as a synthetic resin (e.g., a plastic).

The article holding device 100C may be configured such that the pressing surface 12A, which is at the tip end of the protruded part 12C, presses the extended part 25 of the adsorption pad 2B toward the article W in an adsorbing state of the article W. This makes it much easier to bring the adsorption pad 2B into close contact with the article W, thereby improving the adsorption performance of the adsorption pad 2B with respect to the article W.

### Second Embodiment

The following will give a description of another embodiment of the present disclosure. Note that, for convenience, members having identical functions to those of the foregoing embodiment are given identical reference signs, and a description thereof will be omitted.

### Configuration of Article Holding Device

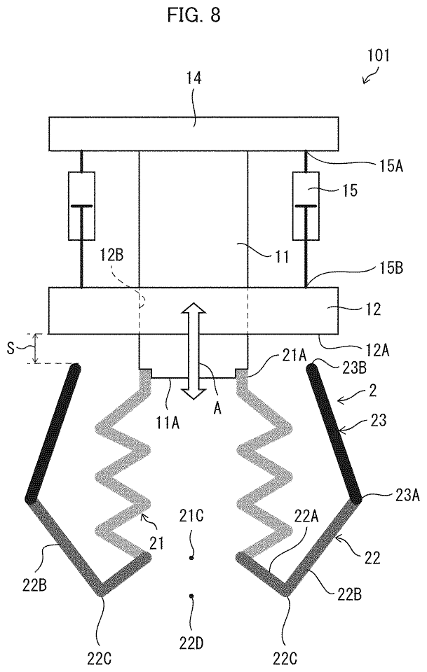

First, the following description will discuss an example of a configuration of an article holding device 101 with reference to FIG. 8. FIG. 8 is a view schematically illustrating an example of a configuration of a main part of the article holding device 101 in accordance with the present embodiment. The article holding device 101 in accordance with the present embodiment differs from the article holding device 100 in accordance with the present embodiment in that, in the article holding device 101, a pressing part 12 is movable relative to a pad attachment part 11 along a direction of a center axis A of a suction port 11A.

As shown in FIG. 8, in the article holding device 101, a head part 1 includes, instead of the spring 13, at least one actuator (driving part) 15 that moves the pressing part 12 toward an article W in an adsorbing state of the article W. Further, the pad attachment part 11 is fixed to a housing 14 of the head part 1, whereas the pressing part 12 is not fixed to the housing 14 but is connected with the at least one actuator 15 fixed to the housing 14.

The at least one actuator 15 includes a plurality of actuators 15 arranged such that the pad attachment part 11 is interposed therebetween and axial directions of the actuators 15 are in parallel with the center axis A of the suction port 11A. Each of the actuators 15 has a first end 15A fixed to the housing 14. Further, each of the actuators 15 has a second end 15B that is opposite to the first end 15A and that is connected with the pressing part 12. Thus, by operating the actuators 15, it is possible to move the pressing part 12 toward the pad attachment part 11 along the direction of the center axis A of the suction port 11A.

### Operation of Article Holding Device

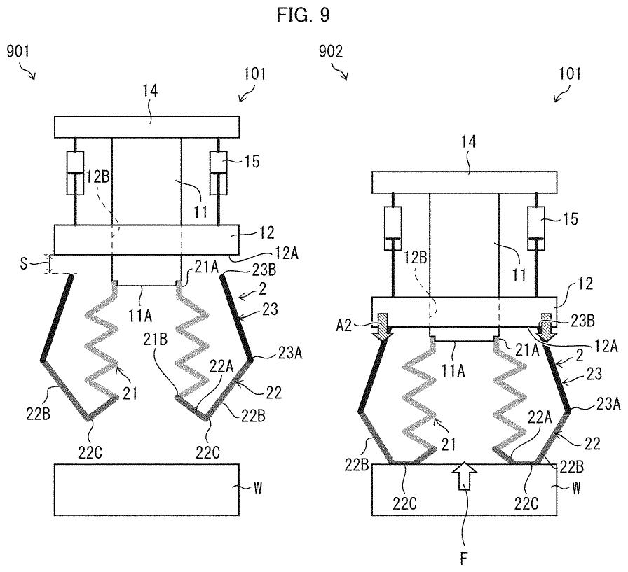

Next, the following description will discuss an example of operation of the article holding device 101 with reference to FIG. 9. FIG. 9 is a view schematically illustrating an example of operation of the article holding device 101. The reference sign “901” in FIG. 9 illustrates a state in which adsorption of the article W is not carried out, whereas the reference sign “902” in FIG. 9 illustrates a state in which adsorption of the article W is carried out.

When the article holding device 101 is lowered toward the article W from the state in which adsorption of the article W is not carried out (shown in the view with the reference sign “901” in FIG. 9), a bent part 22C of the adsorption pad 2 first comes into contact with the article W, and thereafter the adsorption pad 2 is pressed against the article W. Consequently, the adsorption pad 2 is elastically deformed in accordance with the shape of the article W. Consequently, as shown in the view with the reference sign “902” in FIG. 9, a first adsorption part 22A and a second adsorption part 22B of an adsorption part 22 come into close contact with an adsorbed surface of the article W.

During this, the actuators 15 are operated to press the pressing part 12 downward. Consequently, the pressing part 12 moves downward relative to the pad attachment part 11.

As described above, by operating the actuators 15 to move the pressing part 12 downward relative to the pad attachment part 11, the pressing part 12 presses a shape maintaining part 23 toward the article W, as indicated by the arrows A2 in the view with the reference sign “902” in FIG. 9. This makes it much easier to bring the adsorption pad 2 into close contact with the article W, thereby improving the adsorption performance of the adsorption pad 2 with respect to the article W.

### Effects of Article Holding Device

As described above, the article holding device 101 in accordance with the present embodiment includes: the pad attachment part 11 that is provided with the suction port 11A; the adsorption pad 2 that is attached to the pad attachment part 11 and that adsorbs the article W; the pressing part 12 that is movable relative to the pad attachment part 11 along the direction of the center axis A of the suction port 11A and that presses the adsorption pad 2 toward the article W in an adsorbing state of the article W; and the actuators 15 that move the pressing part 12 toward the article W in an adsorbing state of the article W.

In the article holding device 101, the actuators 15 cause the pressing part 12 to move toward the article W, which makes it much easier to bring the adsorption pad 2 into close contact with the article W. Thus, the present embodiment makes it even easier to bring the adsorption pad 2 into close contact with the article W, thereby improving the adsorption performance of the adsorption pad 2 with respect to the article W.

Aspects of the present disclosure can also be expressed as follows:

An article holding device in accordance with a first aspect of the present disclosure includes: a pad attachment part that is provided with a suction port; an adsorption pad that is attached to the pad attachment part and that is configured to adsorb an article; and a pressing part that is movable relative to the pad attachment part along a direction of a center axis of the suction port and that is configured to press the adsorption pad toward the article in an adsorbing state of the article.

According to the above configuration, the pad attachment part and the pressing part are relatively movable so that the pressing part presses the adsorption pad toward the article in an adsorbing state of the article. Thus, the above configuration makes it easier to bring the adsorption pad into close contact with the article, thereby improving the adsorption performance.

An article holding device in accordance with a second aspect of the present disclosure may be configured such that, in the first aspect, the adsorption pad includes a suction part that has a first end connected with the pad attachment part and that has a tubular shape, an adsorption part that is connected with a second end of the suction part which second end is opposite to the first end and that is configured to adsorb the article, and a shape maintaining part that is connected with the adsorption part and that is configured to maintain a shape of the adsorption part in a non-adsorbing state of the article.

According to the above configuration, the shape maintaining part maintains the shape of the adsorption part in a non-adsorbing state of the article. This makes it possible to bring the adsorption part close to the article while maintaining the shape thereof constant, thereby allowing the adsorption part to adsorb the article.

An article holding device in accordance with a third aspect of the present disclosure may be configured such that, in the second aspect, the adsorption part includes a first adsorption part that is connected with the second end of the suction part and that has a diameter which increases with increasing distance from the suction part, and a second adsorption part that is bent relative to the first adsorption part toward the pad attachment part and that has a diameter which increases with increasing distance from the first adsorption part; and the shape maintaining part is connected with the second adsorption part and is located around the suction part.

In accordance with the above configuration, the adsorption pad includes a bent part between the first adsorption part and the second adsorption part. Thus, when the adsorption pad is brought close to the article, the bent part first comes into contact with the article and is elastically deformed according to the shape of the article, and then the first adsorption part and the second adsorption part are elastically deformed so as to come into close contact with the article. Therefore, with the above configuration, the adsorption part is likely to be elastically deformed according to the shape of the article, which enhances the adsorption performance with respect to the article.

An article holding device in accordance with a fourth aspect of the present disclosure may be configured such that, in the second or third aspect, the pressing part is further configured to press the shape maintaining part toward the article.

In accordance with the above configuration, the pressing part presses the adsorption part toward the article via the shape maintaining part, thereby allowing the adsorption part to adsorb the article.

An article holding device in accordance with a fifth aspect of the present disclosure may be configured such that, in the fourth aspect, the pressing part includes a pressing surface that faces the adsorption pad and that is flat; and the pressing surface is further configured to press the shape maintaining part toward the article.

In accordance with the above configuration, the pressing surface of the pressing part, which is configured to press the adsorption pad, is flat, and thus the pressing surface is hardly caught by the adsorption pad, which allows the adsorption pad to easily move in accordance with the shape of the article.

An article holding device in accordance with a sixth aspect of the present disclosure may be configured such that, in the fourth or fifth aspect, the article holding device has a space between the pressing part and the shape maintaining part in a non-adsorbing state of the article.

In accordance with the above configuration, in a non-adsorbing state of the article, the shape maintaining part is in a floating state in which the shape maintaining part is separated from the pad attachment part. Thus, with the above configuration, the adsorption pad is likely to be tilted along tilting of the article, for example, which further improves the adsorption performance with respect to the article.

An article holding device in accordance with a seventh aspect of the present disclosure may be configured such that, in the sixth aspect, the pressing part is further configured to carry out reciprocation movement relative to the pad attachment part along the direction of the center axis; a stroke length of the reciprocation movement of the pressing part is not less than a length of the space in the direction of the center axis and is not more than a sum of the length of the space and a maximum deformation amount of the adsorption pad in the direction of the center axis.

In accordance with the above configuration, in an adsorbing state of the article, even after the pressing part comes into contact with the adsorption pad, the adsorption pad still remains in a close-contact state in which the adsorption pad is pressed against the article with a weak force until the pressing part reaches the stroke end. Then, when the pressing part reaches the stroke end, the adsorption pad is pressed against the article with a strong force, whereby the article is adsorbed. Therefore, with the above configuration, it is possible to bring the adsorption pad into close contact with the article with a relatively weak force, thereby making it possible to suitably adsorb the article which is easily deformed (e.g., a stand pouch).

An article holding device in accordance with an eighth aspect of the present disclosure may be configured such that, in the sixth or seventh aspect, the article holding device further includes: an annular member that is fixed to an end of the shape maintaining part which end faces the pressing part and that is located around the suction part.

In accordance with the above configuration, for example, in an adsorbing state of an article disposed in a tilted state, the annular member comes into contact with the pressing part with the adsorption pad being tilted along the tilting of the article. During this, elastic deformation of the shape maintaining part is suppressed by the annular member, which makes it easier to maintain the state in which the adsorption pad is tilted. Therefore, it is possible to stably adsorb the tilted article by the adsorption pad.

An article holding device in accordance with a ninth aspect of the present disclosure may be configured such that, in the eighth aspect, the annular member includes a large-diameter part that is fixed to the shape maintaining part and a small-diameter part that is located closer to the pressing part than the large-diameter part and that is configured to be pressed by the pressing part in an adsorbing state of the article.

In accordance with the above configuration, the pressing part may have a dimension with which the pressing part can press the small-diameter part. Therefore, it is possible to reduce the size of the pressing part.

An article holding device in accordance with a tenth aspect of the present disclosure may be configured such that, in any one of the first to ninth aspects, the article holding device further includes a driving part (actuator 15) that is configured to move the pressing part toward the article in an adsorbing state of the article.

In accordance with the above configuration, the driving part moves the pressing part toward the article, which makes it much easier to bring the adsorption pad into close contact with the article.

The present disclosure is not limited to the embodiments above, but can be altered by a skilled person in the art within the scope of the claims. The present disclosure also encompasses, in its technical scope, any embodiment derived by combining technical means disclosed in differing embodiments as appropriate.

### REFERENCE SIGNS LIST

2, 2A, 2B: adsorption pad
11: pad attachment part
11A: suction port
12: pressing part
12A: pressing surface
15: actuator (driving part)
21: suction part
21B: second end (second end of suction part)
22: adsorption part
22A: first adsorption part
22B: second adsorption part
23: shape maintaining part
23B: second end (second end of shape maintaining part)
24: annular member
24A: large-diameter part
24B: small-diameter part
A: center axis of suction port
S: space
W: article

1. An article holding device comprising:
a pad attachment part that is provided with a suction port;
an adsorption pad that is attached to the pad attachment part and that is configured to adsorb an article; and
a pressing part that is movable relative to the pad attachment part along a direction of a center axis of the suction port and that is configured to press the adsorption pad toward the article in an adsorbing state of the article.

2. The article holding device according to claim 1, wherein:
the adsorption pad includes
a suction part that has a first end connected with the pad attachment part and that has a tubular shape,
an adsorption part that is connected with a second end of the suction part which second end is opposite to the first end and that is configured to adsorb the article, and
a shape maintaining part that is connected with the adsorption part and that is configured to maintain a shape of the adsorption part in a non-adsorbing state of the article.

3. The article holding device according to claim 2, wherein:
the adsorption part includes
a first adsorption part that is connected with the second end of the suction part and that has a diameter which increases with increasing distance from the suction part, and
a second adsorption part that is bent relative to the first adsorption part toward the pad attachment part and that has a diameter which increases with increasing distance from the first adsorption part; and
the shape maintaining part is connected with the second adsorption part and is located around the suction part.

4. The article holding device according to claim 2, wherein:
the pressing part is further configured to press the shape maintaining part toward the article.

5. The article holding device according to claim 4, wherein:
the pressing part includes
a pressing surface that faces the adsorption pad and that is flat; and
the pressing surface is further configured to press the shape maintaining part toward the article.

6. The article holding device according to claim 4, wherein:
the article holding device has a space between the pressing part and the shape maintaining part in a non-adsorbing state of the article.

7. The article holding device according to claim 6, wherein:
the pressing part is further configured to carry out reciprocation movement relative to the pad attachment part along the direction of the center axis;
a stroke length of the reciprocation movement of the pressing part is not less than a length of the space in the direction of the center axis and is not more than a sum of the length of the space and a maximum deformation amount of the adsorption pad in the direction of the center axis.

8. The article holding device according to claim 6, further comprising:
an annular member that is fixed to an end of the shape maintaining part which end faces the pressing part and that is located around the suction part.

9. The article holding device according to claim 8, wherein:
the annular member includes
a large-diameter part that is fixed to the shape maintaining part and
a small-diameter part that is located closer to the pressing part than the large-diameter part and that is configured to be pressed by the pressing part in an adsorbing state of the article.

10. The article holding device according to claim 1, further comprising:
a driving part that is configured to move the pressing part toward the article in an adsorbing state of the article.
